(19) United States
(12) Patent Application Publication
(10) Pub. No.: US 2003/0147131 A1
(43) Pub. Date: Aug. 7, 2003

(54) Reflection type projection optical system, exposure apparatus and device fabrication method using the same

(76) Inventor: Chiaki Terasawa, Tochigi (JP)

Correspondence Address: MORGAN & FINNEGAN, L.L.P., 345 PARK AVENUE, NEW YORK, NY, 10154, US

(21) Appl. No.: 10/360,152

(22) Filed: Feb. 6, 2003

(30) Foreign Application Priority Data
Feb. 7, 2002 (JP) 2002-030207

(51) Int. Cl. G02B 17/00

(52) U.S. Cl. 359/366; 359/365; 359/727; 359/857

(57) ABSTRACT

A reflection type projection optical system includes six mirrors that serve substantially as a coaxial system, and include, in order from an object side to an image side, a first mirror, a second mirror, a third mirror, a fourth mirror, a fifth mirror, and a sixth mirror to sequentially reflect light, wherein the reflection type projection optical system serves as an imaging system that forms an intermediate image along an optical path between the third mirror and the fifth mirror, and wherein a displacement direction of a principal ray viewed from an optical axis from the first mirror to the second mirror is reverse to that from the third mirror to the sixth mirror.

### BACKGROUND OF THE INVENTION

The present invention relates generally to exposure apparatuses, and more particularly to a reflection type projection (cataoptric) optical system, an exposure apparatus, and a device fabricating method using the same. The reflection type projection optical system use ultraviolet (“UV”) and extreme ultraviolet (“EUV”) light to project and expose an object, such as a single crystal substrate for a semiconductor wafer, and a glass plate for a liquid crystal display (“LCD”).

Along with recent demands for smaller and lower profile electronic devices, finer semiconductor devices to be mounted onto these electronic devices have been increasingly demanded. For example, the design rule for mask patterns has required that an image with a size of a line and space (“L & S”) of less than 0.1 μm be extensively formed and it is expected to require circuit patterns of less than 80 nm in the near future. The L & S denotes an image projected onto a wafer in exposure with equal line and space widths, and serves as an index of exposure resolution.

A projection exposure apparatus as a typical exposure apparatus for fabricating semiconductor devices includes a projection optical system for projecting and exposing a pattern on a mask or a reticle (these terms are used interchangeably in the present application), onto a wafer. The resolution R of the projection exposure apparatus (i.e., a minimum size for a precise image transfer) can be defined using a light-source wavelength λ and the numerical aperture (“NA”) of the projection optical system as in the following equation:

$$R = {k}_{1} \times \frac{λ}{NA} \qquad ( 1 )$$

As the shorter the wavelength becomes and the higher the NA increases, the better the resolution becomes. The recent trend has required that the resolution be a smaller value; however it is difficult to meet this requirement using only the increased NA, and the improved resolution expects use of a shortened wavelength. Exposure light sources have currently been in transition from KrF excimer laser (with a wavelength of approximately 248 nm) and ArF excimer laser (with a wavelength of approximately 193 nm) to F₂ excimer laser (with a wavelength of approximately 157 nm). Practical use of the EUV light is being promoted as a light source.

As a shorter wavelength of light limits usable glass materials for transmitting the light, it is advantageous for the projection optical system to use reflection elements, i.e., mirrors instead of using many refraction elements, i.e., lenses. No applicable glass materials have been proposed for the EUV light as exposure light, and a projection optical system could not include any lenses. It has thus been proposed to form a reflection type reduction projection optical system only with mirrors (e.g., a multilayer film mirror).

A mirror in a reflection type reduction projection optical system forms a multilayer film to enhance reflected light and increase reflectance, but the smaller number of mirrors is desirable to increase reflectance of the entire optical system. In addition, the projection optical system preferably uses the even number of mirrors to avoid mechanical interference between the mask and the wafer by arranging the mask and the wafer at opposite sides with respect to a pupil. As the EUV exposure apparatus has requires a smaller critical dimension (or resolution) than a conventional one, a NA should be increased (e.g., up to 0.2 for a wavelength of 13.4 nm). However, conventional three- and four-mirror systems have a difficulty in decreasing the wave aberration. Accordingly, the increased number of mirrors, such as six, is needed to increase degree of freedom in correcting the wave aberration. Hereinafter, such an optical system is referred to as a six-mirror system in the instant application. Such a six-mirror system has been disclosed, for example, in Japanese Laid-Open Patent Applications Nos. 2000-100694 and 2000-235144.

The six-mirror system proposed in Japanese Laid-Open Patent Application No. 2000-100694 reflects a principal ray near a vertex of a first mirror, and tends to result in the large telecentricity at the object side. Therefore, an object-surface position when offsetting in the optical-axis direction in a scan exposure would easily vary the reduction and distortion on the image surface and deteriorate the imaging performance.

Another disadvantage is that it handles an NA up to about 0.16 but has a difficulty in handling a higher NA. This is because a second reflection optical system from an intermediate image to the image surface includes four mirrors, and it becomes difficult to arrange these mirrors without interfering with a ray of light other than the reflected light as the high NA thickens a beam width in the second reflection optical system. Although a high principal-ray point in the second reflection optical system, in particular, at the third and forth mirrors might enable these mirrors to be arranged without interference, the second mirror as a concave mirror hinders the arrangement. It is conceivable that the object point is made higher to handle the higher NA, a wider angle is incompatible with a correction of aberration as well as causing a large mirror size.

Since a minimum distance between the object surface and the mirror is short e.g., about 20 to 30 mm, it is difficult to maintain a space for a stage mechanism for scanning the object surface. Thus, the illumination light disadvantageously interferes with the stage mechanism when the illumination system is arranged so that it crosses the optical axis of the projection optical system.

A manufacture of the projection system requires an adjustment of decentering, and may easily maintain the decentering accuracy when the mirror has a shape that covers an area of 360° around the optical axis. However, the embodiment in the above reference requires the fourth mirror of an off-axis shape, and thus has a difficulty to adjust the decentering.

A reflection type projection optical system as a six-mirror system proposed in Japanese Laid-Open Patent Application No. 2000-235144 realizes such a comparatively high NA that the NA is about 0.20 to 0.30. However, it is non-telecentric at the object side, increasing an inclined angle of a principal ray of light entering and exiting from a mask or reticle (as an object surface) to an object-surface normal. If there occurs an offset between relative positions of the mask or reticle (as an object surface) and the wafer (as an image surface) in the optical axis direction in a scan exposure, the imaging reduction changes on the wafer, deteriorating the imaging performance.

Since the minimum distance between the object surface and the mirror is short e.g., about 80 to 85 mm, it is still difficult to maintain a space for a stage mechanism for scanning the object surface. Thus, the illumination light disadvantageously interferes with the stage mechanism when the illumination system is arranged so that it crosses the optical axis of the projection optical system.

### BRIEF SUMMARY OF THE INVENTION

Accordingly, it is an exemplified object of the present invention to provide a six-mirror reflection type projection optical system, an exposure apparatus using the same, and a device fabrication method, which is applicable to an EUV lithography system and provides well-balanced reconcilement between a high NA and imaging performance.

A reflection type projection optical system of one aspect of the present invention includes six mirrors that serve substantially as a coaxial system, and include, in order from an object side to an image side, a first mirror, a second mirror, a third mirror, a fourth mirror, a fifth mirror, and a sixth mirror to sequentially reflect light, wherein the reflection type projection optical system serves as an imaging system that forms an intermediate image along an optical path between the third mirror and the fifth mirror, and wherein a displacement direction of a principal ray viewed from an optical axis from the first mirror to the second mirror is reverse to that from the third mirror to the sixth mirror.

The intermediate image may be formed along the optical path between the fourth mirror and the fifth mirror. A center of curvature from the first mirror to the fourth mirror may be located at an object surface side, and a center of curvature from the fifth mirror to the sixth mirror is located at an image surface side. The first to sixth mirrors may be a concave mirror, a convex mirror, a concave mirror, a convex mirror, a convex mirror, and a concave mirror.

An optical axis position of the fourth mirror may be physically located along optical axes between the first mirror and the sixth mirror. Alternatively, an optical axis position of the third mirror may be physically located along optical axes between the fifth mirror and the image surface.

The reflection type projection optical system may further include an aperture stop at a position of the second mirror or between the first mirror and the second mirror.

Each of the six mirrors may have such a shape as covers an area of 360° around the optical axis as a center without interfering with an effective light that contributes to imaging. One of the six mirrors may be an aspheric mirror having a multilayer film. Alternatively, all of the six mirrors may be aspheric mirrors having a multilayer film.

The reflection type projection optical system may be a twice-imaging system. The light may have a wavelength of 200 nm or less. The light may be extreme ultraviolet light having a wavelength of 20 nm or less. The reflection type projection optical system may be telecentric at the image surface side.

An exposure apparatus of another aspect of the present invention includes the above reflection type projection optical system, a first stage for holding a mask so as to position a pattern on the mask at an object surface, a second stage for holding a substrate so as to position a photosensitive layer applied onto the substrate at an image surface, an illumination apparatus for illuminating the mask using circular extreme ultraviolet light corresponding to a field of the reflection type projection optical system, and a mechanism for synchronously scanning the first and second stages while the illumination apparatus illuminates the mask using the extreme ultraviolet light.

A device fabricating method of another aspect of the present invention includes the steps of exposing an object using the above exposure apparatus, and performing a predetermined process for the exposed object. Claims for a device fabricating method for performing operations similar to that of the above exposure apparatus cover devices as intermediate and final products. Such devices include semiconductor chips like an LSI and VLSI, CCDs, LCDs, magnetic sensors, thin film magnetic heads, and the like.

Other objects and further features of the present invention will become readily apparent from the following description of the preferred embodiments with reference to accompanying drawings.

### BRIEF DESCRIPTION OF THE DRAWINGS

FIG. 1 is a schematic sectional view showing a reflection type projection optical system and its optical path of one embodiment according to the present invention.

FIG. 2 is a schematic sectional view showing a reflection type projection optical system and its optical path of another embodiment according to the present invention.

FIG. 3 is a schematic sectional view showing a reflection type projection optical system and its optical path of another embodiment according to the present invention.

FIG. 4 is a schematic sectional view showing an optical path of a principal ray in the reflection type projection optical system shown in FIG. 1.

FIG. 5 is a schematic block diagram showing an exposure apparatus that includes a reflection type projection optical system shown in FIG. 1.

FIG. 6 is a flowchart for explaining a method for fabricating devices (semiconductor chips such as ICs, LSIs, and the like, LCDs, CCDs, etc.).

FIG. 7 is a detailed flowchart for Step 4 of wafer process shown in FIG. 6.

### DETAILED DESCRIPTION OF THE PREFERRED EMBODIMENTS

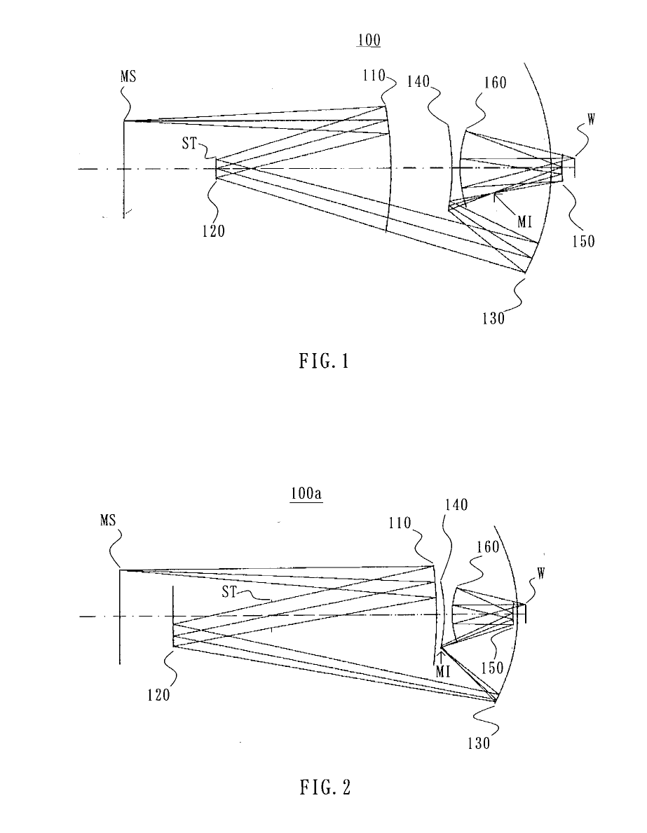

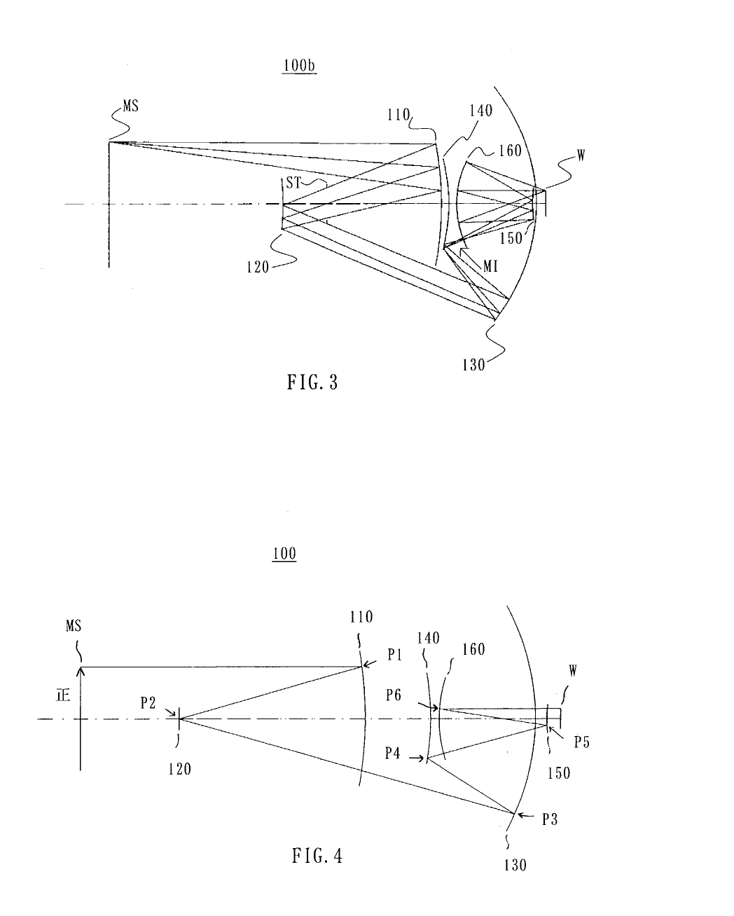

A description will now be given of a reflection type projection optical system 100 and an exposure apparatus 200 as one aspect of the present invention with reference to the accompanying drawings. The present invention is not limited to these embodiments and each element is replaceable within a scope that achieves the objects of the present invention. The same reference numeral in each figure denotes the same element, and a description thereof will be omitted. Here, FIG. 1 is a schematic sectional view showing the reflection type projection optical system 100 and its optical path of one embodiment according to the present invention. FIG. 2 is a schematic sectional view showing a reflection type projection optical system 100a and its path as a variation of the reflection type reduction projection optical system 100 shown in FIG. 1. FIG. 3 is a schematic sectional view showing a reflection type projection optical system 100 b and its path as a variation of the reflection type reduction projection optical system 100 shown in FIG. 1. Unless otherwise specified, the reflection type projection optical system 100 generalizes the reflection type reduction projection optical systems 100a and 100b. FIG. 4 is a schematic sectional view of the reflection type projection optical system 100 shown in FIG. 1.

Referring to FIG. 1, the inventive reflection type projection optical system 100 (hereinafter simply called “projection optical system 100”) reduces and projects a pattern on an object surface (MS), such as a mask surface, onto an image surface (W), such as a substrate surface and an object surface to be exposed. The reflection type projection optical system 100 is an optical system particularly suitable for the EUV light (with a wavelength of, for example, 13.4 nm). The projection optical system 100 includes six mirrors that substantially have, in order of reflecting light from the object surface (MS) side, a first (concave) mirror 110, a second (convex) mirror 120, a third (concave) mirror 130, a fourth (convex) mirror 140, a fifth (convex) mirror 150, and a sixth (concave) mirror 160. Four mirrors, i.e., the first to fourth mirrors 110 to 140, form an intermediate image MI, and two mirrors, i.e., the fifth mirror 150 and the sixth mirror 160, reform the intermediate image MI on the image surface W.

The inventive projection optical system 100 is arranged substantially as a coaxial system, i.e., a coaxial optical system that is axially symmetrical around one optical axis. However, the respective mirrors 110 to 160 in the projection optical system 100 do not have to be arranged to be perfectly coaxial so as to correct or adjust aberration. For example, they may slightly decenter for aberrational improvements.

A circular aperture stop ST is located at the second mirror 120. A diameter of the aperture stop ST may be variable or fixed. A variable diameter of the aperture stop ST may change the NA of the optical system. The aperture stop ST as a variable stop advantageously provides a deeper depth of focus suitable for stabilization of images.

Characteristically, the inventive projection optical system 100 of such a configuration reverses a displacement direction, i.e., an up-to-down direction from P1 to P2, of a principal ray viewed from an optical axis from the first mirror 110 to the second mirror 120 to a displacement direction, i.e., a down-to-up direction from P3 to P6 through P4 and P5, from the third mirror 130 to the sixth mirror 160.

In addition, a center of curvature from the first mirror 110 to the fourth mirror 140 is located at an object surface (MS) side, and a center of curvature from the fifth mirror 150 to the sixth mirror 160 is located at an image surface W side.

At present, the reflection type projection optical system is believed to be the last way in the photolithography, and a higher NA would be increasingly demanded due to a finer mask pattern in the future. However, a beam width thickens along with the higher NA, making the mirror arrangement difficult without interference (or shield) between the mirror(s) and light at the image surface W side.

For such a high NA, the inventive projection optical system 100 may maintain an optical path without interference between the mirror and light by arranging only two mirrors, i.e., the fifth mirror 150 and the sixth mirror 160 between the intermediate image MI and image surface W and providing them with large power.

For the telecentricity at the object surface MS side, the aperture stop ST is located at the second mirror 120 and the first mirror 110 is provided with positive power. In addition, a principal-ray point of the third mirror 130 is set high and the incidence pupil is set far, providing such telecentricity with small distortion that an image size changes an extremely little when the object surface MS varies in the optical-axis direction. The inventive projection optical system 100 arranges an inclined angle θ of the principal ray from the object surface MS to a normal of the object surface MS preferably less than 8°, and more preferably less than 3°.

As described above, it is possible to maintain a large minimum distance between the object surface MS and the mirror (i.e., a distance between the object surface MS and the second mirror 120 in this embodiment) by making the reflection angle at the second mirror 120 comparatively large. Thereby, an optical path of the stage mechanism for the object surface MS and the illumination system may be arranged with certain degree of freedom and without interference with the mirror in the projection system. The inventive projection optical system 100 sets the distance between the object surface MS and the second mirror 120 to be 150 mm or larger.

For manufacture convenience, the fourth mirror 140 has such a shape that covers an area of 360° around the optical axis as a center by physically arranging an optical-axis position of the fourth mirror 140 between an optical-axis position of the first mirror 110 and that of the second mirror 160. Thus, the accuracy of decentering may be easily maintained for stable quality. Only the third mirror 130 has an off-axis shape that does not has the optical axis as a center. However, it may have a shape that covers an area of 360° around the optical axis as a center by arranging the third mirror 130 is arranged between the sixth mirror 160 and the image surface W.

Referring now to FIG. 2, a description will be given of a difference between the projection optical system 100 and the reflection type projection optical system 100a as a variation of the reflection type projection optical system 100 shown in FIG. 1. The projection optical system 100a arranges the intermediate image MI along the optical path between the third mirror 130 and the fourth mirror 140. Compared with the projection optical system 100, this is disadvantage for a higher NA, but it may realize similarly high NA.

The aperture stop ST is arranged as a circular aperture stop near the second mirror 120 between the first mirror 110 and the second mirror 120, and the second mirror 120 is formed as an aspheric surface. For manufacture convenience, each of these six mirrors, i.e., first to sixth mirrors 110 to 160 has an optical-axis center position actually arranged along the optical axis and thus may be so shaped that it covers an area of 360° around the optical axis as a center.

The inventive projection optical system 100 of such a configuration is a six-mirror system, and advantageously increases NA of the optical system. It is such an approximately telecentric optical system at the object side that it may facilitate good imaging with a small change in image size and less distortion even when the object surface moves in the optical-axis direction. In addition, the inventive projection optical system 100 makes the exit light telecentric at the image surface W side, and thus its reduction is less affected even when the image surface W moves in the optical-axis direction. In other words, the inventive projection optical system 100 is a both-side telecentric optical system and facilitates stable imaging performance.

As the projection optical system 100 is arranged as a coaxial system, it may advantageously correct aberration in the ring-shaped image surface around the optical axis as a center. The projection optical system 100 is an intermediate-image forming optical system, and provides well-balanced aberrational corrections. The mirror type of the projection optical system 100 may reduce the inclination of the principal ray from the object plane MS, and thus is applicable to both a transmittance type mask (or a pattern molding mask) and a reflection type mask.

The first to sixth mirrors 110 to 160 are convex or concave mirrors as described above, but the present invention does not limit the mirrors 110 to 160 to a combination of the above convex and concave mirrors. Of course, a formation of an intermediate image using the first to fourth mirrors 110 to 140 as in the instant embodiment, and a reformation of the image using the fifth and sixth mirrors 150 and 160 would determine shapes of some mirrors to some extent. Preferably, the fifth and sixth mirrors 150 and 160 are convex and concave mirrors, respectively, for imaging with a predetermined NA and a back focus. Here, a “back focus” means an interval between the last mirror surface and the image surface (W).

The first mirror 110 is preferably a concave mirror to reflect the principal ray from the object surface MS and bring it close to the optical axis. The third mirror 130 needs to reflect the EUV light reflected on the second mirror 120 and raise it to the optical-axis direction. Therefore, the third mirror 130 is preferably a concave mirror.

Although the second and fourth mirrors 120 and 140 may select freely a concave or convex mirror, as described later, the mirror shape should be determined so that the sum of Petzval terms may be zero or in the neighborhood of zero. For example, the second mirror 120 is preferably a convex mirror when the first mirror 110 is a concave mirror. The fourth mirror 140 is preferably a convex mirror when the third mirror 130 is a concave mirror. Thereby, a sign of the Petzval term may be alternately set for the first mirror 110 to the sixth mirror 160 so as to partially correct the Petzval sum.

Although the instant embodiment configures, as described above, the first to sixth mirrors 110 to 160 as a concave or convex mirror, and forms aspheric shapes on their reflection surfaces, at least one or more mirrors out of the first to sixth mirrors 110 to 160 have an aspheric surface according to the present invention. As a mirror having an aspheric surface advantageously facilitates a correction of aberration, the aspheric surface is preferably applied to many possible (desirably, sixth) mirrors. A shape of the aspheric surface in these first to sixth mirrors 110 to 160 is defined as Equation 2 as an equation of a generic aspheric surface:

$$Z = \frac{{ch}^{2}}{1 + \sqrt{1 - ( 1 + k ) {c}^{2} {h}^{2}}} + A {h}^{4} + {Bh}^{6} + {Ch}^{8} + {Dh}^{10} + {Eh}^{12} + {Fh}^{14} + {Gh}^{16} + {Hh}^{18} + {Jh}^{20} + \qquad ( 2 )$$

where “Z” is a coordinate in an optical-axis direction, “c” is a curvature (i.e., a reciprocal number of the radius r of curvature), “h” is a height from the optical axis, “k” a conic constant, “A” to “J” are aspheric coefficients of 4^{th} order, 6^{th} order, 8^{th} order, 10^{th} order, 12^{th} order, 14^{th} order, 16^{th} order, 18^{th} order, 20^{th} order, respectively.

These six, i.e., first to sixth, mirrors 110 to 160 have the sum of the Petzval terms in the neighborhood of zero or preferably zero in order to flatten the image surface (W) in the optical system. Thereby, a sum of refracting power of each mirror surface is made nearly zero. In other words, where r₁₁₀˜r₁₆₀ are the radii of curvature for respective mirrors (in which subscripts correspond to the reference numerals of the mirrors), the first to sixth mirrors 110 to 160 in this embodiment meet the Equation 3 or 4:

$$\begin{matrix}\frac{1}{{r}_{110}} - \frac{1}{{r}_{120}} + \frac{1}{{r}_{130}} - \frac{1}{{r}_{140}} + \frac{1}{{r}_{150}} - \frac{1}{{r}_{160}} = 0 & ( 3 ) \\ \frac{1}{{r}_{110}} - \frac{1}{{r}_{120}} + \frac{1}{{r}_{130}} - \frac{1}{{r}_{140}} + \frac{1}{{r}_{150}} - \frac{1}{{r}_{160}} \approx 0 & ( 4 )\end{matrix}$$

A multilayer film for reflecting the EUV light is applied onto the surface of the mirrors 110 to 160, and serves to enhance the light. A multilayer applicable to the mirrors 110 to 160 of the instant embodiment includes, for example, a Mo/Si multilayer film including alternately laminated molybdenum (Mo) and silicon (Si) layers on a mirror's reflection surface or a Mo/Be multilayer film including alternately laminating molybdenum (Mo) and beryllium (Be) layers on the mirror's reflection surface. A mirror including the Mo/Si multilayer film may obtain reflectance of 67.5% for a wavelength range near a wavelength of 13.4 nm, and a mirror including the Mo/Be multilayer film may obtain reflectance of 70.2% for a wavelength range near a wavelength of 11.3 nm. Of course, the present invention does not limit the multilayer film to the above materials, and may use any multilayer film that has an operation or effect similar to that of the above.

A description will now be given of illumination experiment results using the inventive reflection type projection optical systems 100, 100 a and 100b. In FIGS. 1 to 3, MS is a reflection type mask located at the object surface, and W is a wafer located at the image surface. The reflection type projection optical systems 100, 100a and 100 b illuminate the mask MS using an illumination system (not shown) for emitting the EUV light with a wavelength of about 13.4 nm, and reflects the reflected EUV light from the mask MS via the first (concave) mirror 110, second (convex) mirror 120, third (concave) mirror 130, fourth (convex) mirror 140, fifth (convex) mirror 150, and sixth (concave) mirror 160 arranged in this order. Then, a reduced image of the mask pattern is formed on the wafer W located at the image surface. The reflection type projection optical system 100 shown in FIG. 1 has NA=0.25, reduction=⅕, an object point of 140 to 150 mm, an image point of 28 to 30 mm, and an arc-shaped image surface with a width of 2.0 mm. Table 1 indicates the numerical values (such as radius of curvature, surface intervals, and coefficients of aspheric surfaces) of the reflection type projection optical system 100 shown in FIG. 1.

TABLE 1

| MIRROR | RADII OF | SURFACE | CONIC |
|---|---|---|---|
| NUMBERS | CURVATURE | INTERVALS | CONSTANTS K |
| OBJECT | ∞ | 831.59794 | |
| SURFACE (MS) | | | |
| MIRROR 110 | −1100.00476 | −544.09370 | 0.34850 |
| MIRROR 120 | −1121.11292 | 1039.80113 | 5.53725 |
| STOP (ST) | | | |
| MIRROR 130 | −670.27365 | −305.38831 | −0.71853 |
| MIRROR 140 | −691.50401 | 338.10793 | 1.92040 |
| MIRROR 150 | 366.08323 | −313.10793 | 7.74425 |
| MIRROR 160 | 380.43714 | 353.08293 | 0.00938 |
| IMAGE | ∞ | | |
| SURFACE (W) | | | |

| COEFFICIENTS | | | | |
|---|---|---|---|---|
| OF ASPHERIC | | | | |
| SURFACES | A | B | C | D |
| MIRROR 110 | 2.15067E−11 | −1.26316E−16 | 4.54827E−21 | −5.79875E−26 |
| MIRROR 120 | 1.18375E−8 | 1.0476E−12 | 8.66746E−17 | −2.26192E−21 |
| MIRROR 130 | −2.26384E−10 | −3.88639E−16 | 1.01855E−22 | −2.54887E−27 |
| MIRROR 140 | 5.32637E−9 | −1.29869−13 | 5.14685E−18 | −1.25562E−22 |
| MIRROR 150 | 1.57177E−8 | 6.42267E−13 | −1.70133E−18 | 2.33076E−20 |
| MIRROR 160 | 2.42728E−11 | 1.06377E−16 | −2.07962E−22 | 1.31636E−26 |

| — | E | F | G | H |
|---|---|---|---|---|
| MIRROR 110 | 2.91138E−31 | 0 | 0 | 0 |
| MIRROR 120 | 5.12421E−24 | 0 | 0 | 0 |
| MIRROR 130 | 8.11915E−34 | 0 | 0 | 0 |
| MIRROR 140 | 1.30009E−27 | 0 | 0 | 0 |
| MIRROR 150 | −2.83120E−24 | 0 | 0 | 0 |
| MIRROR 160 | −1.00659E−30 | 0 | 0 | 0 |

The reflection type projection optical system 100 shown in FIG. 1 includes such aberrations (calculated at several points on the image point) without manufacture errors that wavefront aberration is 0.033 λrms and maximum distortion is −2.4 nm. This is a diffraction limited optical system for a wavelength of 13.4 nm.

The minimum distance between the object surface MS and the mirror (i.e., a distance between the object surface MS and the second mirror 120) is 287.5 mm, which is a distance enough to avoid interference between the stage mechanism for the object surface MS and the illumination optical system.

As described above, the inventive reflection type projection optical system 100 has a small inclined angle θ of the principal ray from the object surface MS, and indicates values as shown in Table 2 below:

TABLE 2

| IMAGE | ANGLE OF PRINCIPAL | TANGENT OF ANGLE OF |
|---|---|---|
| POINT mm | RAY θ (°) | PRINCIPAL RAY |
| 140.0 | 0.02 | 0.00 |
| 150.0 | 0.00 | 0.00 |

Thus, it is understood that an image size does not change even when the object surface (MS) moves in the optical-axis direction, and the inventive reflection type projection optical system 100 may provide excellent imaging and is a telecentric optical system at both sides of the object surface MS and image surface W.

The reflection type projection optical system 100a shown in FIG. 2 has NA of 0.25, reduction of ⅕, an object point of 140 to 150 mm, an image point of 28 to 30 mm, and an arc-shaped image surface with a width of 2.0 mm. Table 3 indicates the numerical values (such as radius of curvature, surface intervals, and coefficients of aspheric surfaces) of the reflection type projection optical system 100a shown in FIG. 2.

TABLE 3

| MIRROR | RADII OF | SURFACE | CONIC |
|---|---|---|---|
| NUMBERS | CURVATURE | INTERVALS | CONSTANTS K |
| OBJECT | ∞ | 1017.36014 | |
| SURFACE (MS) | | | |
| MIRROR 110 | −1340.92409 | −529.09840 | −0.60567 |
| STOP (ST) | ∞ | −316.76317 | |
| MIRROR 120 | ∞ | 1103.46785 | 0.0 |
| MIRROR 130 | −551.14798 | −232.60629 | −0.78578 |
| MIRROR 140 | −401.67897 | 217.66486 | −3.61597 |
| MIRROR 150 | 245.88832 | −192.66486 | 8.50543 |
| MIRROR 160 | 254.81606 | 232.63986 | 0.19582 |
| IMAGE | ∞ | | |
| SURFACE (W) | | | |

| COEFFICIENTS | | | | |
|---|---|---|---|---|
| OF ASPHERIC | | | | |
| SURFACES | A | B | C | D |
| MIRROR 110 | 4.99767E−10 | −2.67953E−15 | 2.80855E−20 | −2.20964E−25 |
| MIRROR 120 | 3.94638E−11 | 7.68153E−15 | −3.67373E−19 | 2.35596E−23 |
| MIRROR 130 | 1.44098E−10 | −7.39487E−15 | 9.53135E−20 | −6.57132E−25 |
| MIRROR 140 | 1.38568E−8 | −4.80932E−14 | −3.52473E−17 | 2.39962E−21 |
| MIRROR 150 | −6.58357E−8 | −2.59360E−12 | −6.43791E−16 | −7.25744E−20 |
| MIRROR 160 | −9.31344E−10 | −1.48150E−14 | −1.64629E−19 | −9.12790E−24 |

| — | E | F | G | H |
|---|---|---|---|---|
| MIRROR 110 | 7.87878E−31 | 0 | 0 | 0 |
| MIRROR 120 | −7.13546E−28 | 0 | 0 | 0 |
| MIRROR 130 | 1.90481E−30 | 0 | 0 | 0 |
| MIRROR 140 | −5.57651E−26 | 0 | 0 | 0 |
| MIRROR 150 | −3.98192E−24 | 0 | 0 | 0 |
| MIRROR 160 | 1.85190E−28 | 0 | 0 | 0 |

The reflection type projection optical system 100a shown in FIG. 2 includes such aberrations (calculated at several points on the image point) without manufacture errors that wavefront aberration is 0.040 λrms and maximum distortion is 4.9 nm. This is a diffraction limited optical system for a wavelength of 13.4 nm.

The minimum distance between the object surface MS and the mirror (i.e., a distance between the object surface MS and the second mirror 120) is 171.5 mm, which is a distance enough to avoid interference between the stage mechanism for the object surface MS and the illumination optical system.

Similar to the reflection type projection optical system 100, the inventive reflection type projection optical system 100 a has a small inclined angle θ of the principal ray from the object surface MS, and indicates values as shown in Table 4 below:

TABLE 4

| IMAGE | ANGLE OF PRINCIPAL | TANGENT OF ANGLE OF |
|---|---|---|
| POINT mm | RAY θ (°) | PRINCIPAL RAY |
| 140.0 | 2.39 | 0.0417 |
| 150.0 | 2.57 | 0.0449 |

Thus, it is understood that an image size does not change even when the object surface (MS) moves in the optical-axis direction, and the inventive reflection type projection optical system 100 a may provide excellent imaging.

The reflection type projection optical system 100b shown in FIG. 3 has NA of 0.35, reduction of ⅕, an object point of 195.0 to 200.0 mm, an image point of 39.0 to 40.0 mm, and an arc-shaped image surface with a width of 1.0 mm. Table 5 indicates the numerical values (such as radius of curvature, surface intervals, and coefficients of aspheric surfaces) of the reflection type projection optical system 100b shown in FIG. 3.

TABLE 5

| MIRROR | RADII OF | SURFACE | CONIC |
|---|---|---|---|
| NUMBERS | CURVATURE | INTERVALS | CONSTANTS K |
| OBJECT | ∞ | 1066.61553 | |
| SURFACE (MS) | | | |
| MIRROR 110 | −947.53202 | −367.39683 | −1.07462 |
| STOP (ST) | ∞ | −140.79413 | |
| MIRROR 120 | −965.62329 | 811.57544 | 9.91943 |
| MIRROR 130 | −567.72301 | −278.38447 | −0.84240 |
| MIRROR 140 | −485.60661 | 266.67869 | −0.83634 |
| MIRROR 150 | 343.28913 | −241.67869 | 8.86136 |
| MIRROR 160 | 313.94434 | 283.38447 | 0.10633 |
| IMAGE | ∞ | | |
| SURFACE (W) | | | |

| COEFFICIENTS | | | | |
|---|---|---|---|---|
| OF ASPHERIC | | | | |
| SURFACES | A | B | C | D |
| MIRROR 110 | 3.44671E−10 | −1.85935E−15 | 1.61613E−20 | −1.30861E−25 |
| MIRROR 120 | 6.16641E−10 | 6.58344E−14 | −2.10628E−18 | 5.59896E−22 |
| MIRROR 130 | −3.49575E−10 | −1.91814E−15 | 1.15338E−20 | −9.16302E−26 |
| MIRROR 140 | 3.96317E−9 | 8.09779E−14 | 3.14434E−18 | −2.58469E−22 |
| MIRROR 150 | −2.41519E−8 | 2.67752E−14 | −4.29379E−17 | −2.50792E−20 |
| MIRROR 160 | −1.41904E−10 | −1.09969E−15 | −6.42842E−21 | −1.18203E−25 |

| — | E | F | G | H |
|---|---|---|---|---|
| MIRROR 110 | 1.58516E−30 | −2.16521E−35 | 1.49317E−40 | 0 |
| MIRROR 120 | −8.53632E−26 | 7.19689E−30 | −2.56397−34 | 0 |
| MIRROR 130 | 4.57245E−31 | −1.54102E−36 | 2.43597E−42 | 0 |
| MIRROR 140 | −4.59135E−27 | 5.24072E−31 | −8.62009E−36 | 0 |
| MIRROR 150 | 7.07018E−24 | −1.31059E−27 | 9.48516E−32 | 0 |
| MIRROR 160 | 4.23419E−30 | −1.68128E−34 | 2.59095−39 | 0 |

The reflection type projection optical system 100b shown in FIG. 3 includes such aberrations (calculated at several points on the image point) without manufacture errors that wavefront aberration is 0.027 λrms and maximum distortion is 2.7 nm. This is a diffraction limited optical system for a wavelength of 13.4 nm.

Similar to the reflection type projection optical system 100, the inventive reflection type projection optical system 100a has a small inclined angle θ of the principal ray from the object surface MS, and indicates values as shown in Table 6 below:

TABLE 6

| IMAGE | ANGLE OF PRINCIPAL | TANGENT OF ANGLE OF |
|---|---|---|
| POINT mm | RAY θ (°) | PRINCIPAL RAY |
| 195.0 | 4.39 | 0.0768 |
| 200.0 | 4.51 | 0.0789 |

Thus, it is understood that an image size does not change even when the object surface (MS) moves in the optical-axis direction, and the inventive reflection type projection optical system 100b may provide excellent imaging.

As described above, the inventive reflection type projection optical system 100 is a reflection type projection optical system that realizes diffraction limited performance with such a high NA as 0.25 or larger for the wavelength of EUV light, and maintains the minimum distance between the object surface MS and mirror. Therefore, it would be unlikely to cause interference between the stage mechanism for the object surface MS and illumination optical system, and may form all the mirrors such that an optical-axis center position of each of them actually covers an area of 360° including the actually arranged optical-axis center. Therefore, it has a manufacture advantage and excellent imaging performance due to the small inclination of the principal ray from the object surface MS.

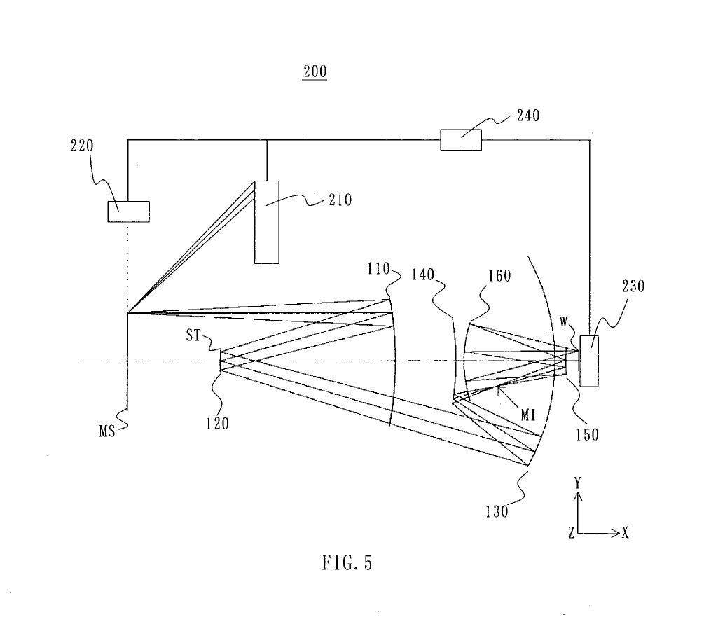

A description will be given below of an exposure apparatus 200 including the inventive reflection type projection optical system 100 with reference to FIG. 5. Here, FIG. 5 is a schematic block diagram showing an exposure apparatus 200 that includes a reflection type projection optical system 100. The exposure apparatus is a projection exposure apparatus that exposes in a step-and-scan manner using EUV light (with a wavelength of, e.g., 13.4 nm) as illumination light for exposure.

Referring to FIG. 5, the exposure apparatus 200 includes an illumination apparatus 210, a mask MS, a mask stage 220 for supporting the mask MS, a reflection type projection optical system 100, an object to be exposed W, a wafer stage 230 for supporting the wafer W, and a controller 240 that is controllably connected to the illumination apparatus 210, mask stage 220 and wafer stage 230.

At least the optical path through which the EUV light travels should preferably be maintained in a vacuum atmosphere, although not shown in FIG. 5, since the EUV light has low transmittance for air. In FIG. 5, XYZ defines a three-dimensional space, and the direction Z is a normal direction to the XY plane.

The illumination apparatus 210 uses circular EUV light (with a wavelength of, for example, 13.4 nm) corresponding to a circular field of the reflection type projection optical system, to illuminate the mask MS, and includes a light source and illumination optical system (not shown). The illumination apparatus 210 may use any technology known in the art for the light source and illumination optical system, and a detailed description thereof will be omitted. For example, the illumination optical system may include a condenser optical system, an optical integrator, an aperture stop, a blade, etc., and use any technique conceivable to those skilled in the art.

The mask MS is a reflection or transmittance type mask, and forms a circuit pattern (or image) to be transferred. It is supported and driven by a mask stage 220. The diffracted light emitted from the mask MS is projected onto the object W after reflected by the projection optical system 100. The mask MS and object W are arranged optically conjugate with each other. Since the exposure apparatus 200 is a step-and-scan exposure apparatus, the mask MS and object W are scanned to transfer the pattern on the mask MS, onto the object W.

The mask stage 220 supports the mask MS and is connected to a mobile mechanism (not shown). The mask stage 220 may use any structure known in the art. The mobile mechanism (not show) may use a linear motor, etc., and drives the mask stage 220 in the direction Y so as to move the mask MS under control by the controller 240. The exposure apparatus 200 scans while synchronizes the mask MS and object W through the controller 240.

The reflection type projection optical system 100 is an optical system that reduces and projects a pattern on the mask MS onto the image surface. The reflection type projection optical system 100 may use any of the above embodiments, and a detailed description thereof will be omitted. Although FIG. 5 uses the reflection type optical system 100 shown in FIG. 1, the present invention is not limited to this illustrative embodiment.

The object W is a wafer in this embodiment, but may be a LCD and another object to be exposed. Photoresist is applied to the object W. A photoresist application step includes a pretreatment, an adhesion accelerator application treatment, a photo-resist application treatment, and a pre-bake treatment. The pretreatment includes cleaning, drying, etc. The adhesion accelerator application treatment is a surface reforming process so as to enhance the adhesion between the photoresist and a base (i.e., a process to increase the hydrophobicity by applying a surface active agent), through a coat or vaporous process using an organic film such as HMDS (Hexamethyl-disilazane). The pre-bake treatment is a baking (or burning) step, softer than that after development, which removes the solvent.

The object W is supported by the wafer stage 230. For example, the wafer stage 230 uses a linear motor to move the object W in XYZ directions. The mask MS and object W are, for example, scanned synchronously under control by the controller 240, and the positions of the mask stage 220 and wafer stage 230 are monitored, for example, by a laser interferometer and the like, so that both are driven at a constant speed ratio.

The controller 240 includes a CPU and memory (not shown) and controls operations of the exposure apparatus 200. The controller 240 is electrically connected to (a mobile mechanism (not shown) for) the mask stage 220, and (a mobile mechanism (not shown) for) the wafer stage 230. The CPU includes a processor regardless of its name, such as an MPU, and controls each module. The memory includes a ROM and RAM, and stores a firmware for controlling the operations of the exposure apparatus 200.

In exposure, the EUV light emitted from the illumination apparatus 210 illuminates the mask MS, and the pattern on the mask MS onto the object W. The instant embodiment provides a circular or ring-shaped image surface, and scans the entire surface on the mask MS by scanning the mask MS and object W with a speed ratio corresponding to the reduction ratio.

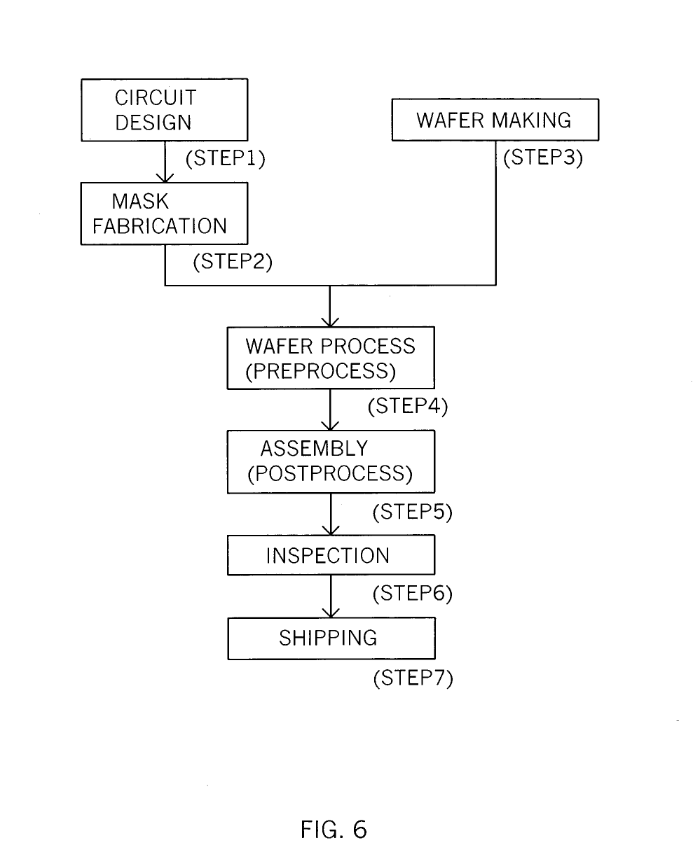

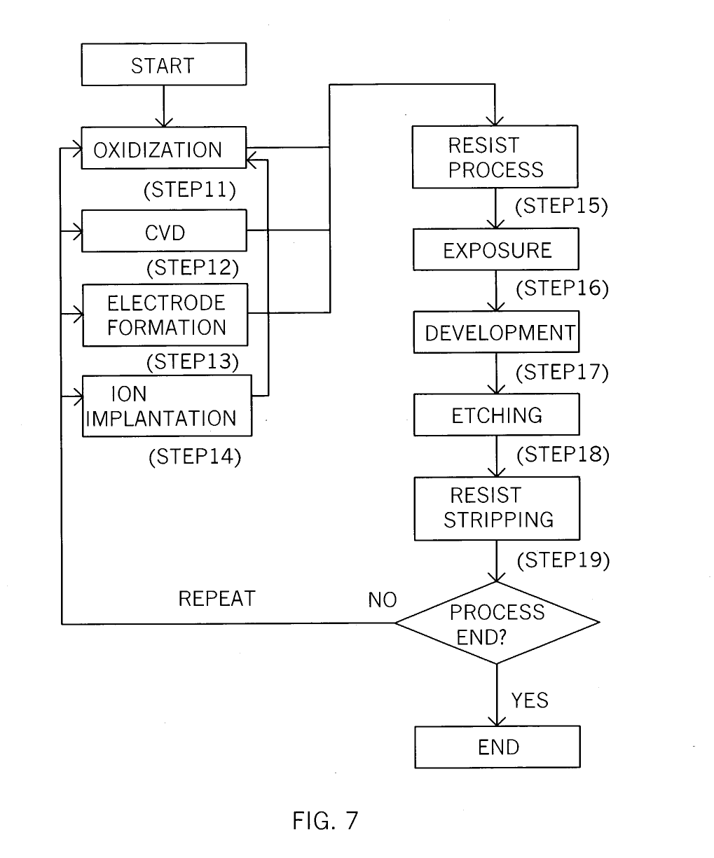

Referring to FIGS. 6 and 7, a description will now be given of an embodiment of a device fabricating method using the above mentioned exposure apparatus 200. FIG. 6 is a flowchart for explaining a fabrication of devices (i.e., semiconductor chips such as IC and LSI, LCDs, CCDs, etc.). Here, a description will be given of a fabrication of a semiconductor chip as an example. Step 1 (circuit design) designs a semiconductor device circuit. Step 2 (mask fabrication) forms a mask having a designed circuit pattern. Step 3 (wafer making) manufactures a wafer using materials such as silicon. Step 4 (wafer process), which is referred to as a pretreatment, forms actual circuitry on the wafer through photolithography using the mask and wafer. Step 5 (assembly), which is also referred to as a post-treatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 7 is a detailed flowchart of the wafer process in Step 4 shown in FIG. 6. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ion into the wafer. Step 15 (resist process) applies a photosensitive material onto the wafer. Step 16 (exposure) uses the exposure apparatus 200 to expose a circuit pattern on the mask onto the wafer. Step 17 (development) develops the exposed wafer. Step 18 (etching) etches parts other than a developed resist image. Step 19 (resist stripping) removes disused resist after etching. These steps are repeated, and multilayer circuit patterns are formed on the wafer. The device fabrication method of this embodiment may manufacture higher quality devices than the conventional one. Thus, the device fabrication method using the exposure apparatus 200, and the devices as finished goods also constitute one aspect of the present invention.

Further, the present invention is not limited to these preferred embodiments, and various variations and modifications may be made without departing from the scope of the present invention. For example, the reflection type projection optical system of this embodiment has a coaxial system having a rotationally symmetrical aspheric surface, but it may have a rotationally asymmetrical aspheric surface. The present invention is applicable a reflection type projection optical system for non-EUV ultraviolet light with a wavelength of 200 nm or less, such as ArF excimer laser and F₂ excimer laser, as well as to an exposure apparatus that scans and exposes a large screen, or that exposes without scanning.

Thus, the inventive reflection type projection optical system uses a six-mirror system to realize a high NA, e.g., 0.25 or higher. In addition, it may reduce the inclination of the principal ray from the object surface (and realize the approximately perfect telecentricity), reducing an image size change and the influence on distortion even when the object surface moves in the optical-axis direction within a range of a manufacture error of the stage mechanism for the object surface. The sufficient minimum distance between the object surface and mirror would prevent interference between the mirror and a lens barrel in the projection optical system, and interference between the stage mechanism for the object surface and illumination optical system. The decentering of each mirror may be easily and accurately maintained and each mirror is advantageously manufactured, since each mirror has such a shape that an optical-axis center position covers an area of 360° including an actually arranged optical-axis center. Thereby, the inventive reflection type projection optical system realizes an optical system with a high NA and excellent imaging performance, the exposure apparatus having this reflection type projection optical system may provide high quality devices with excellent exposure performance including a throughput.

What is claimed is:

1. A reflection type projection optical system comprising six mirrors that serve substantially as a coaxial system, and include, in order from an object side to an image side, a first mirror, a second mirror, a third mirror, a fourth mirror, a fifth mirror, and a sixth mirror to sequentially reflect light,
wherein said reflection type projection optical system serves as an imaging system that forms an intermediate image along an optical path between the third mirror and the fifth mirror, and
wherein a displacement direction of a principal ray viewed from an optical axis from the first mirror to the second mirror is reverse to that from the third mirror to the sixth mirror.

2. A reflection type projection optical system according to claim 1, wherein the intermediate image is formed along the optical path between the fourth mirror and the fifth mirror.

3. A reflection type projection optical system according to claim 1, wherein a center of curvature from the first mirror to the fourth mirror is located at an object surface side, and a center of curvature from the fifth mirror to the sixth mirror is located at an image surface side.

4. A reflection type projection optical system according to claim 1, wherein the first to sixth mirrors are a concave mirror, a convex mirror, a concave mirror, a convex mirror, a convex mirror, and a concave mirror.

5. A reflection type projection optical system according to claim 1, wherein an optical axis position of the fourth mirror is physically located along optical axes between the first mirror and the sixth mirror.

6. A reflection type projection optical system according to claim 1, wherein an optical axis position of the third mirror is physically located along optical axes between the fifth mirror and the image surface.

7. A reflection type projection optical system according to claim 1, further comprising an aperture stop at a position of the second mirror.

8. A reflection type projection optical system according to claim 1, further comprising an aperture stop between the first mirror and the second mirror.

9. A reflection type projection optical system according to claim 1, wherein each of said six mirrors has such a shape as covers an area of 360° around the optical axis as a center without interfering with an effective light that contributes to imaging.

10. A reflection type projection optical system according to claim 1, wherein one of said six mirrors is an aspheric mirror having a multilayer film.

11. A reflection type projection optical system according to claim 1, wherein all of said six mirrors are aspheric mirrors having a multilayer film.

12. A reflection type projection optical system according to claim 1, wherein said reflection type projection optical system is a twice-imaging system.

13. A reflection type projection optical system according to claim 1, wherein the light has a wavelength of 200 nm or less.

14. A reflection type projection optical system according to claim 1, wherein the light is extreme ultraviolet light having a wavelength of 20 nm or less.

15. A reflection type projection optical system according to claim 1, wherein said reflection type projection optical system is telecentric at the image surface side.

16. An exposure apparatus comprising:
a reflection type projection optical system;
a first stage for holding a mask so as to position a pattern on the mask at an object surface;
a second stage for holding a substrate so as to position a photosensitive layer applied onto the substrate at an image surface;
an illumination apparatus for illuminating the mask using circular extreme ultraviolet light corresponding to a field of said reflection type projection optical system; and
a mechanism for synchronously scanning said first and second stages while said illumination apparatus illuminates the mask using the extreme ultraviolet light,
wherein a reflection type projection optical system comprises six mirrors that serve substantially as a coaxial system, and include, in order from an object side to an image side, a first mirror, a second mirror, a third mirror, a fourth mirror, a fifth mirror, and a sixth mirror to sequentially reflect light,
wherein said reflection type projection optical system serves as an imaging system that forms an intermediate image along an optical path between the third mirror and the fifth mirror, and
wherein a displacement direction of a principal ray viewed from an optical axis from the first mirror to the second mirror is reverse to that from the third mirror to the sixth mirror.

17. A device fabricating method comprising the steps of:
exposing an object using an exposure apparatus; and
performing a predetermined process for the exposed object,
wherein an exposure apparatus includes:
a reflection type projection optical system;
a first stage for holding a mask so as to position a pattern on the mask at an object surface;
a second stage for holding a substrate so as to position a photosensitive layer applied onto the substrate at an image surface;
an illumination apparatus for illuminating the mask using circular extreme ultraviolet light corresponding to a field of said reflection type projection optical system; and
a mechanism for synchronously scanning said first and second stages while said illumination apparatus illuminates the mask using the extreme ultraviolet light,
wherein a reflection type projection optical system comprises six mirrors that serve substantially as a coaxial system, and include, in order from an object side to an image side, a first mirror, a second mirror, a third mirror, a fourth mirror, a fifth mirror, and a sixth mirror to sequentially reflect light,
wherein said reflection type projection optical system serves as an imaging system that forms an intermediate image along an optical path between the third mirror and the fifth mirror, and
wherein a displacement direction of a principal ray viewed from an optical axis from the first mirror to the second mirror is reverse to that from the third mirror to the sixth mirror.
